(19) United States
(12) Patent Application Publication
(10) Pub. No.: US 2015/0002250 A1
(43) Pub. Date: Jan. 1, 2015

(54) ELECTROMAGNETIC CONTACTOR

(71) Applicants: FUJI ELECTRIC CO., LTD., Kawasaki-shi (JP); FUJI ELECTRIC FA COMPONENTS & SYSTEM CO., LTD., Chuo-ku, Tokyo (JP)

(72) Inventors: Osamu Kashimura, Hino-shi (JP); Masaru Isozaki, Ichihara-shi (JP); Hiroyuki Tachikawa, Yokohama-shi (JP); Kouetsu Takaya, Kounosu-shi (JP); Yasuhiro Naka, Kounosu-shi (JP); Yuji Shiba, Kounosu-shi (JP)

(21) Appl. No.: 14/344,789

(22) PCT Filed: Oct. 3, 2012
(86) PCT No.: PCT/JP2012/006359

§ 371 Date: Mar. 13, 2014

(30) Foreign Application Priority Data
Oct. 7, 2011 (JP) 2011-223144

(51) Int. Cl. H01H 1/58

(52) U.S. Cl. CPC H01H 1/58
USPC 335/204

(57) ABSTRACT

An electromagnetic contactor includes a contact mechanism including a pair of fixed contacts having fixed contact portions and interposed in a current conduction path, and a movable contact having a pair of movable contact portions capable of contacting to and separating from the pair of fixed contact portions. At least one of the pair of fixed contacts or the movable contact is formed in a shape to form magnetic fields generating Lorentz forces opposing electromagnetic repulsion forces generated in an opening direction between the fixed contact portions and the movable contact portions when current is conducted. External connection conductors are connected to external connection terminals of the fixed contacts, an attachment direction of fixed portions fixed to the external connection terminal of the fixed contacts is set to cross a current flow direction flowing through the movable contact.

### TECHNICAL FIELD

The present invention relates to an electromagnetic contactor including fixed contacts interposed in a current path and a movable contact and arranged to generate Lorentz forces opposing electromagnetic repulsion forces causing the movable contact to separate from the fixed contacts when current is conducted.

### BACKGROUND ART

As an electromagnetic contactor which carries out the opening/closing of a current path, there has heretofore been proposed a switch of, for example, a configuration wherein a fixed contact is bent in a U-shape when viewed from a side, a fixed contact point is formed in a bent portion, and a movable contact point of a movable contact is disposed to be capable of contacting to and separating from the fixed contact point. The switch is arranged so that an opening speed is enhanced by increasing an electromagnetic repulsion force acting on the movable contact when a large current is interrupted, thus rapidly extending an arc (for example refer to PTL1).

Also, there has been proposed a contact structure of an electromagnetic contactor which causes an arc to be driven by a magnetic field generated by current flowing in the same configuration (for example refer to PTL 2).

### CITATION LIST

### Patent Literature

PTL 1: JP-A-2001-210170
PTL 2: JP-A-4-123719

### SUMMARY OF INVENTION

### Technical Problem

Meanwhile, the heretofore known example described in the PTL 1 is arranged such that the fixed contact is formed in the U-shape when viewed from a side, thus increasing an electromagnetic repulsion force to be generated. Because of this increased electromagnetic repulsion force, it is possible to enhance the opening speed of the movable contact when the large current is interrupted due to a short circuit or the like, rapidly extend the arc, and limit a fault current to a small value.

However, with an electromagnetic contactor configuring a circuit combined with a fuse or a circuit breaker, it is necessary to prevent a movable contact from opening due to electromagnetic repulsion forces when a large current is conducted. In order to apply the heretofore known example described in the PTL 2, generally, the spring force of a contact spring securing the contact pressure of the movable contact against the fixed contacts is increased.

When the contact pressure generated by the contact spring is increased in this way, it is also necessary to increase the thrust generated by an electromagnet which drives the movable contact, and the size of the overall configuration is increased. Alternatively, there is an unsolved problem that it is necessary to combine the electromagnetic contactor with a fuse or circuit breaker that has higher current limiting effect and is superior in interruption performance.

In order to solve the unsolved problems, it is conceivable that at least either the fixed contacts or movable contact is formed in a shape such as to increase Lorentz forces opposing electromagnetic repulsion forces generated in an opening direction between the fixed contacts and movable contact when current is conducted.

In this case, it is possible to increase the Lorentz forces opposing the electromagnetic repulsion forces generated in the opening direction between the fixed contacts and movable contact when the current is conducted, and thus suppress the opening direction electromagnetic repulsion forces. However, there is an unsolved problem that, depending on the shape of external connection conductors connected to external connection terminals of the fixed contacts of the electromagnetic contactor, the Lorentz forces that suppress the opening direction electromagnetic repulsion forces are weakened by being affected by magnetic fields generated around the external connection conductors by the currents flowing through the external connection conductors.

Therefore, the invention, having been contrived focusing on the heretofore described unsolved problems of the heretofore known example, has an object of providing an electromagnetic contactor capable of suppressing electromagnetic repulsion forces causing a movable contact to open when current is conducted, without being effected from the magnetic fields of the external connection conductors and without increasing the size of the overall configuration.

### Solution to Problem

In order to achieve the object, a first aspect of an electromagnetic contactor according to the invention includes a contact mechanism including a pair of fixed contacts having fixed contact portions and interposed in a current conduction path and a movable contact having a pair of movable contact portions capable of contacting to and separating from the pair of fixed contact portions. At least one of the pair of fixed contacts or movable contact is formed in a shape such as to form magnetic fields generating Lorentz forces opposing electromagnetic repulsion forces generated in an opening direction between the fixed contact portions and the movable contact portions when current is conducted. Furthermore, external connection conductors are connected to external connection terminals of the fixed contacts, an attachment direction of fixed portions fixed to the external connection terminal of the fixed contacts being set to cross a current flow direction flowing through the movable contact.

According to this configuration, as at least either the fixed contacts or movable contact is formed in a shape, for example, an L-shape or a C-shape, such as to generate Lorentz forces opposing electromagnetic repulsion forces generated in the opening direction between the fixed contacts and movable contact when current is conducted, it is possible to prevent the movable contact from opening when a large current is conducted. Also, the attachment direction of the fixed portions of the external connection conductors connected to the external connection terminals of the fixed contacts is set so as to cross the current flow direction flowing through the movable contact. Because of this, magnetic fields generated in the fixed portions of the external connection conductors are prevented from affecting magnetic fields generating Lorentz forces.

Also, a second aspect of the electromagnetic contactor according to the invention is such that each of the external connection conductors includes a conductor portion connected on a side opposite to the external connection terminal of the fixed portion in a direction parallel to an extension direction of the movable contact, and the conductor portion has a direction of current flow reverse to that of the movable contact.

According to this configuration, the conductor portions connected to the fixed portions of the external connection conductors are disposed so as to be parallel to the extension direction of the movable contact and so that the direction of currents flowing through the conduction portions is in reverse of the direction of current flowing through the movable contact. Because of this, it is possible to increase the density of magnetic fluxes generating the Lorentz forces by making the orientation of magnetic fluxes generated by the conductor portions the same as the orientation of magnetic fluxes forming the magnetic fields generating the Lorentz forces.

Also, a third aspect of the electromagnetic contactor according to the invention is such that each of the external connection conductors has a busbar including a protection unit.

According to this configuration, due to the busbar configuring the protection unit, it is possible to increase the density of magnetic fluxes in the magnetic fields generating the Lorentz forces opposing electromagnetic repulsion forces generated in an opening direction between the fixed contacts and movable contact when current is conducted.

Also, a fourth aspect of the electromagnetic contactor according to the invention includes a contact mechanism including a pair of fixed contacts interposed in a current conduction path and having fixed contact portions, and a movable contact having a pair of movable contact portions capable of contacting to and separating from the pair of fixed contact portions. The contact mechanism is such that at least one of the pair of fixed contacts or movable contact is formed in a shape such as to form magnetic fields generating Lorentz forces opposing electromagnetic repulsion forces generated in an opening direction between the fixed contact portions and movable contact portions when current is conducted. Further, a magnetic body suppressing an effect of magnetic fields generated in external connection conductors connected to the fixed contacts is disposed so as to cover the contact mechanism.

According to this configuration, it is possible to suppress the weakening of the Lorentz forces by the magnetic body shielding the magnetic fields generated by the currents flowing through the external connection conductors connected to the external terminals of the fixed contacts from affecting the magnetic fields generating the Lorentz forces.

Also, a fifth aspect of the electromagnetic contactor according to the invention is such that the movable contact includes a conductive plate supported by a movable portion and having contact portions on two end sides of a front or rear surface. Also, each of the fixed contacts includes an L-shaped conductive plate portion having a first conductive plate portion supporting the fixed contact portion facing the contact portion of the conductive plate and directed toward an outer side of the end of the conductive plate in parallel to the conductive plate, and a second conductive plate portion extending from an outward end portion of the first conductive plate portion through the outer side of the end portion of the conductive plate.

According to this configuration, the density of magnetic fluxes generating the Lorentz forces opposing the electromagnetic repulsion forces which cause the movable contact and fixed contacts to open when current is conducted through the electromagnetic contactor is increased in the second conductive plate portions configuring the L-shaped conductive plate portions.

Also, a sixth aspect of the electromagnetic contactor according to the invention is such that each of the fixed contacts, having a third conductive plate portion extending inward from the end portion of the second conductive plate portion in parallel to the conductive plate and is configured in a C-shape.

According to this configuration, as the direction of currents flowing through the third conductive plate portions is the reverse of the direction of current flowing through the movable contact, it is possible to further increase the density of magnetic fluxes generating the Lorentz forces.

Also, a seventh aspect of the electromagnetic contactor according to the invention is such that the movable contact includes a conductive plate portion supported by a movable portion, C-shaped bent portions formed on two ends of the conductive plate portion, and contact portions formed on each surface of the C-shaped bent portions facing the conductive plate portion. Also, the fixed contacts include L-shaped conductive plate portions having a pair of first conductive plate portions, each having a contact portion formed inside the U-shaped bent portion and disposed in parallel to the conductive plate portion to contact the corresponding contact portion of the movable contact, and second conductive plate portions extending from an inner side end of each of the pair of first conductive plate portions through the inner side of an end portion of the U-shaped bent portion.

According to this configuration, it is possible, on the movable contact side, to generate the Lorentz forces opposing the electromagnetic repulsion forces which cause the movable contact and fixed contacts to open when current is conducted through the electromagnetic contactor.

### Advantageous Effects of Invention

According to the invention, it is possible to generate the Lorentz forces opposing the electromagnetic repulsion forces generated in die opening direction between the fixed contacts and movable contact when a large current is conducted through the contact mechanism having the fixed contacts interposed in the current conduction path and the movable contact. Because of this, it is possible to reliably prevent the movable contact from opening when the large current is conducted without using a mechanical pressing force. Also, it is possible to prevent the Lorentz forces from weakening by preventing the magnetic fields generated by the currents flowing through the external connection conductors from affecting the magnetic fields generating the Lorentz forces opposing the opening direction electromagnetic repulsion forces when current is conducted. Furthermore, when the external connection conductors are formed with the conductive portions having a current flow in a direction reverse to that of the movable contact, it is possible to increase the density of magnetic fluxes generating the Lorentz forces.

### BRIEF DESCRIPTION OF DRAWINGS

FIG. 1 is a sectional view showing a first embodiment of an electromagnetic contactor according to the invention.

FIGS. 2(a)-2(c) are plan views of FIG. 1, wherein FIG. 2(a) is a plan view showing a state in which external connection conductors extend in opposite directions, FIG. 2(b) is a plan view showing a state in which the external connection conductors extend in the same direction, and FIG. 2(c) is a plan view showing a heretofore known example.

FIGS. 3(a)-3(d) are diagrams showing a contact mechanism which can be applied to the invention, wherein FIG. 3(a) is a perspective view, FIG. 3(b) is a sectional view showing the contact mechanism when opened, FIG. 3(c) is a sectional view showing the contact mechanism when closed, and FIG. 3(d) is a sectional view showing magnetic fluxes when closed.

FIGS. 4(a)-4(c) are plan views of a second embodiment of the invention, wherein FIG. 4(a) is a plan view showing U-shaped external connection conductors, FIG. 4(h) is a plan view showing L-shaped external connection conductors, and FIG. 4(c) is a plan view showing cranked external connection conductors.

FIG. 5 is a configuration diagram showing a protection unit.

FIG. 6 is a sectional view showing a third embodiment of the electromagnetic contactor of the invention.

FIG. 7(a)-7(c) are diagrams showing another example of the contact mechanism which can be applied to the invention, wherein FIG. 7(a) is a perspective view, FIG. 7(b) is a sectional view showing an open state, and FIG. 7(c) is a sectional view showing a closed state.

FIGS. 8(a)-8(c) are diagrams showing still another example of the contact mechanism which can be applied to the invention, wherein FIG. 8(a) is a perspective view, FIG. 8(b) is a sectional view showing an open state, and FIG. 8(c) is a sectional view showing a closed state.

### DESCRIPTION OF EMBODIMENTS

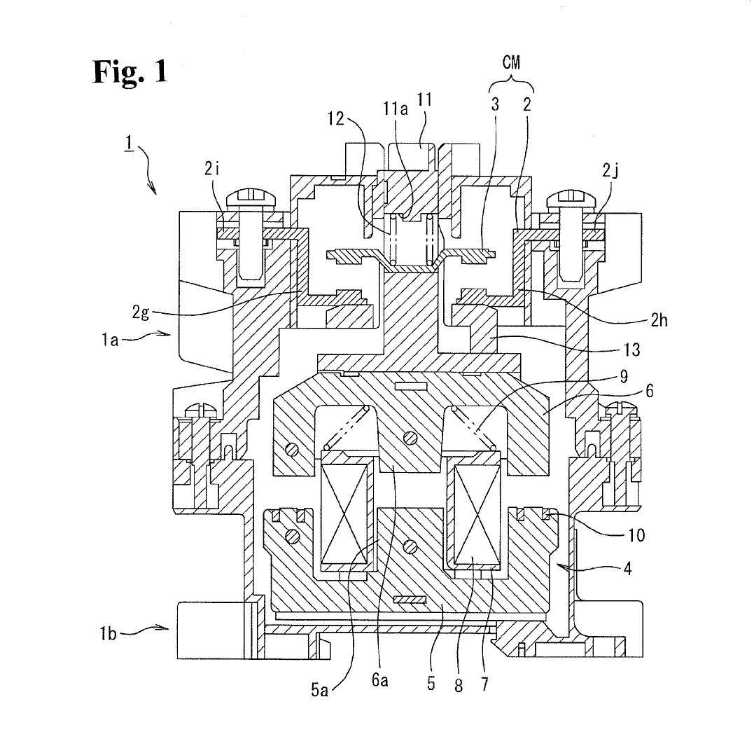

Hereafter, a description will be given, based on the drawings, of embodiments of the invention. FIG. 1 is a sectional view showing an electromagnetic contactor to which a contact mechanism according to the invention is applied.

In FIG. 1, reference 1 is a main body case made of, for example, synthetic resin. The main body case 1 has a dual-partitioning structure formed of an upper case 1a and a lower case 1b. A contact mechanism CM is installed in the upper case 1a. The contact mechanism CM includes fixed contacts 2 disposed fixed to the upper case 1a and a movable contact 3 disposed so as to be capable of contacting to and separating from the fixed contacts 2.

Also, an operating electromagnet 4 which drives the movable contact 3 is disposed in the lower case 1b. The operating electromagnet 4 is such that a fixed iron core 5 formed of an E-shaped leg type laminated steel plate and a movable iron core 6 similarly formed of an E-shaped leg type laminated steel plate are disposed opposite to each other.

An electromagnetic coil 8, wound in a coil holder 7, which is supplied with a single-phase alternating current is fixed to a central leg portion 5a of the fixed iron core 5. Also, a return spring 9 which urges the movable iron core 6 in a direction away from the fixed iron core 5 is disposed between the upper surface of the coil holder 7 and the root of a central leg 6a of the movable iron core 6.

Furthermore, a shading coil 10 is embedded in the upper end face of the outer side leg portion of the fixed iron core 5. It is possible, due to the shading coil 10, to suppress variations in electromagnetic attractive force, noise, and vibration caused by a change in alternating flux in a single-phase alternating current electromagnet.

Further, a contact holder 11 is connected to the upper end of the movable iron core 6. The movable contact 3 is held, in an insertion hole 11a formed on the upper end side of the contact holder 11 in a direction perpendicular to the axis, by being pressed downward against the fixed contacts 2 by a contact spring 12 so as to obtain a predetermined contact pressure.

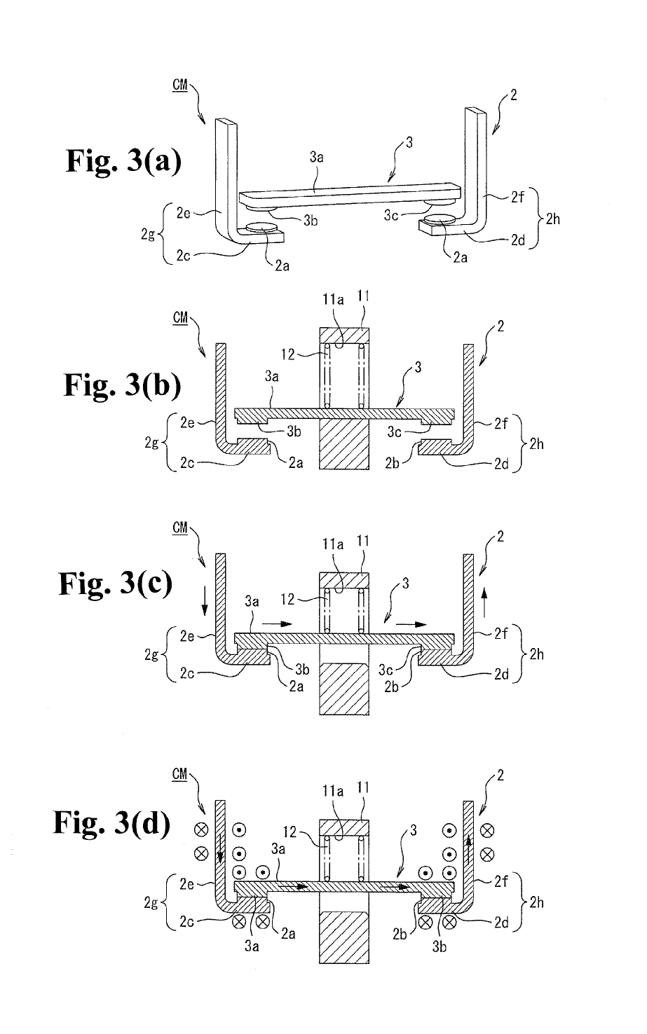

As shown in enlarged dimension in FIGS. 3(a)-3(d), the movable contact 3 is such that the central portion thereof is configured of an elongated rod-shaped conductive plate portion 3a pressed by the contact spring 12, and movable contact portions 3b and 3c are formed one on each end side lower surface of the conductive plate portion 3a.

Meanwhile, as shown in enlarged dimension in FIGS. 3(a)-3(d), each of the fixed contacts 2 includes an L-shaped conductive plate portion 2g, 2h which is formed of a first conductive plate portion 2c, 2d, supporting the corresponding one of the pair of fixed contact portions 2a and 2b facing the movable contact portions 3b and 3c of the movable contact 3 from below, which is directed outward parallel to the conductive plate portion 3a, and a second conductive plate portion 2e, 2f extending upward, through the outer side of each respective end portion of the conductive plate portion 3a, from an outer side end portion of the first conductive plate portion 2c, 2d which is on the outer side of the conductive plate portion 3. Further, external connection terminals 2i and 2j extended toward the outer side of the upper case 1a and fixed are connected respectively to the respective upper ends of the L-shaped conductive plate portions 2g and 2h, as shown in FIG. 1.

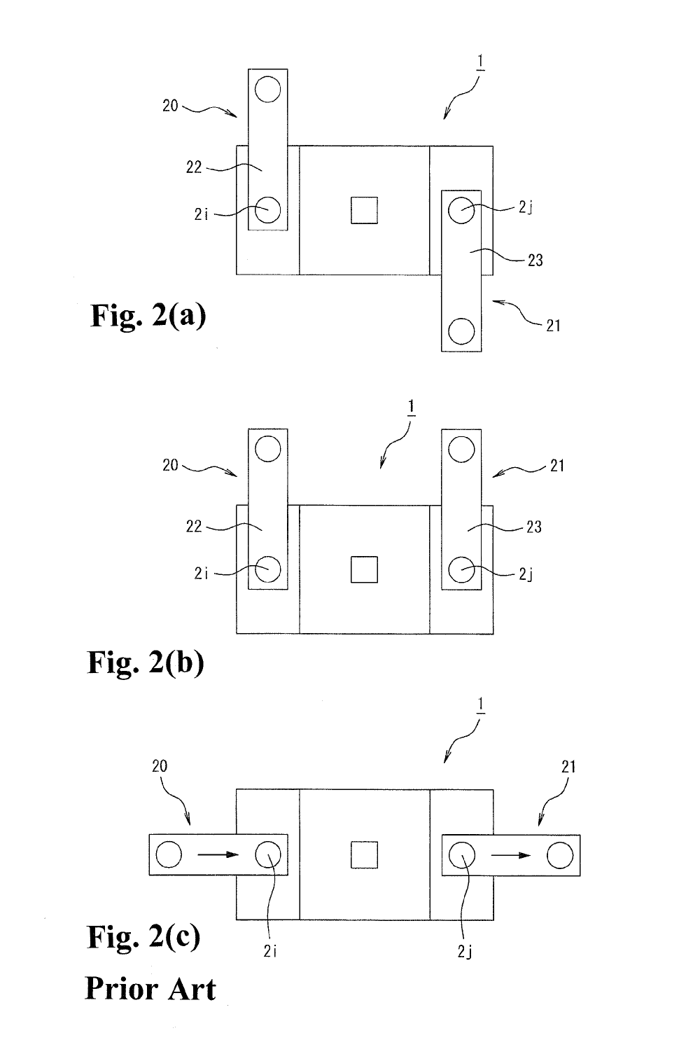

Further, external connection conductors 20 and 21 are connected to the external connection terminals 2i and 2j, as shown in FIGS. 2(a)-2(c). The external connection conductors 20 and 21 are connected so that fixed portions 22 and 23 connected to the external connection terminals 2i and 2j extend in a direction perpendicular to a direction in which current flows through the conductive plate portion 3a of the movable contact 3. Herein, the external connection conductors 20 and 21 may extend either in opposite directions, as shown in FIG. 2(a), or in the same direction, as shown in FIG. 2(b).

Next, a description will be given of an operation of the heretofore described first embodiment.

For now, in a state in which the electromagnetic coil 8 of the operating electromagnet 4 is in a non-energized state, no electromagnetic attractive force is generated between the fixed iron core 5 and movable iron core 6, the movable iron core 6 is urged by the return spring 9 in a direction in which the movable iron core 6 separates upward from the fixed iron core 5, and the upper end of the movable iron core 6 is held in a current interruption position by abutting against a stopper 13.

In a state in which the movable iron core 6 is in the current interruption position, the movable contact 3 contacts the bottom portion of the insertion hole 11a of the contact holder 11 by the contact spring 12, as shown in FIG. 3(a). In this state, the movable contact portions 3b and 3c formed one on each end side of the conductive plate portion 3a of the movable contact 3 are separated upward from the fixed contact portions 2a and 2b of the fixed contact 2, and the contact mechanism CM is in an open state.

When a single-phase alternating current is supplied to the electromagnetic coil 8 of the operating electromagnet 4 in the open state of the contact mechanism CM, an attractive force is generated between the fixed iron core 5 and movable iron core 6, and the movable iron core 6 is attracted downward against the return spring 9. By so doing, the movable contact 3 supported by the contact holder 11 descends, and the movable contact portions 3b and 3c contact the fixed contact portions 2a and 2b of the fixed contact 2 due to the contact pressure of the contact spring 12, thus attaining a closed state.

When the closed state is attained, a large current in the order of, for example, several ten kiloamperes input from, for example, the external connection terminal 2i of the fixed contact 2 connected to a direct current power supply (not shown) is supplied to the movable contact portion 3b of the movable contact 3 through the second conductive plate portion 2e, first conductive plate portion 2c, and fixed contact portion 2a. The large current supplied to the movable contact portion 3b is supplied to the fixed contact portion 2b through the conductive plate portion 3a and movable contact portion 3c. The large current supplied to the fixed contact portion 2b is supplied to the first conductive plate portion 2d, second conductive plate portion 2f, and external connection terminal 2j, and a current conduction path through which the current is supplied to an external load is formed.

At this time, electromagnetic repulsion forces are generated in a direction such as to cause the movable contact portions 3b and 3c to open between the fixed contact portions 2a and 2b of the fixed contacts 2 and the movable contact portions 3b and 3c of the movable contact 3.

However, the fixed contacts 2 are such that as the L-shaped conductive plate portions 2g and 2h are formed by the first conductive plate portions 2c and 2d and second conductive plate portions 2e and 2f, as shown in FIG. 3(a), by the heretofore described current path shown in FIG. 3(c) being formed, the magnetic fields shown in FIG. 3(d) are formed in response to the current flowing through the movable contact 3. Because of this, Lorentz forces which cause the movable contact portions 3b and 3c to be pressed toward the fixed contact portion 2a and 2b sides against the opening direction electromagnetic repulsion forces can be caused to act on the conductive plate portion 3a of the movable contact 3 in accordance with Fleming's left-hand rule.

Consequently, even when electromagnetic repulsion forces are generated in a direction such as to cause the movable contact 3 to open, it is possible to generate Lorentz forces opposing the electromagnetic repulsion forces, meaning that it is possible to reliably prevent the movable contact 3 from opening. Because of this, it is possible to reduce the pressing force of the contact spring 12 supporting the movable contact 3, as a result of which t is also possible to reduce the thrust generated by the operating electromagnet 4, and it is thus possible to reduce the size of the overall configuration.

Moreover, in this case, it being only necessary to form the L-shaped conductive plate portions 2g and 2h in the fixed contacts 2, it is possible to easily carry out the processing of the fixed contacts 2, and there is no need for a separate member which generates an electromagnetic force or mechanical force opposing the opening direction electromagnetic repulsion forces, meaning that it does not happen that the number of parts increases, and it is thus possible to suppress an increase in the size of the overall configuration.

Furthermore, the fixed portions 22 and 23 of the external connection conductors 20 and 21 connected to the external connection terminals 2i and 2j of the fixed contacts 2 extend in a direction perpendicular to the direction in which current flows through the conductive plate portion 3a of the movable contact 3. Because of this, the magnetic field generated by the current flowing through the fixed portion 22 of the external connection conductor 20 does not act in a direction such as to weaken the magnetic field generated by the current flowing through the conductive plate portion 3a of the movable contact 3, and it is thus possible to generate large Lorentz forces.

Incidentally, a consideration will be given of a case in which the fixed portions 22 and 23 of the external connection conductors 20 and 21 are extended parallel to the direction in which the current flows through the conductive plate portion 3a of the movable contact 3 and connected to the external connection terminals 2i and 2h of the fixed contacts 2, as shown in FIG. 2(c). In this case, the magnetic fields generated by the currents flowing through the fixed portions 22 and 23 of the external connection conductors 20 and 21 interfere with the magnetic field generated by the current flowing through the conductive plate portion 3a of the movable contact 3. Because of this, the Lorentz forces opposing the electromagnetic repulsion forces generated in a direction such as to cause the movable contact 3 to open when current is conducted decreases by the magnetic field generated in the conductive plate portion 3a of the movable contact 3 being weakened.

Subsequently, when a current interruption condition is attained by interrupting the current supplied to the operating electromagnet 4 in the closed state of the contact mechanism CM, the movable contact portions 3b and 3c of the movable contact 3 move upward away from the fixed contact portions 2a and 2b of the L-shaped conductive plate portions 2g and 2h of the fixed contact 2, as shown in FIG. 3(b). At this time, arcs are generated between the fixed contact portions 2a and 2b and movable contact portions 3b and 3c.

The arcs generated in this way are extinguished by an arc extinguishing mechanism such as an arc extinguishing magnet disposed along the movable contact 3, although not shown, and the currents between the contact portions 2a and 2b of the fixed contacts 2 and the movable contact portions 3b and 3c of the movable contact 3 are interrupted, thus returning to the open state.

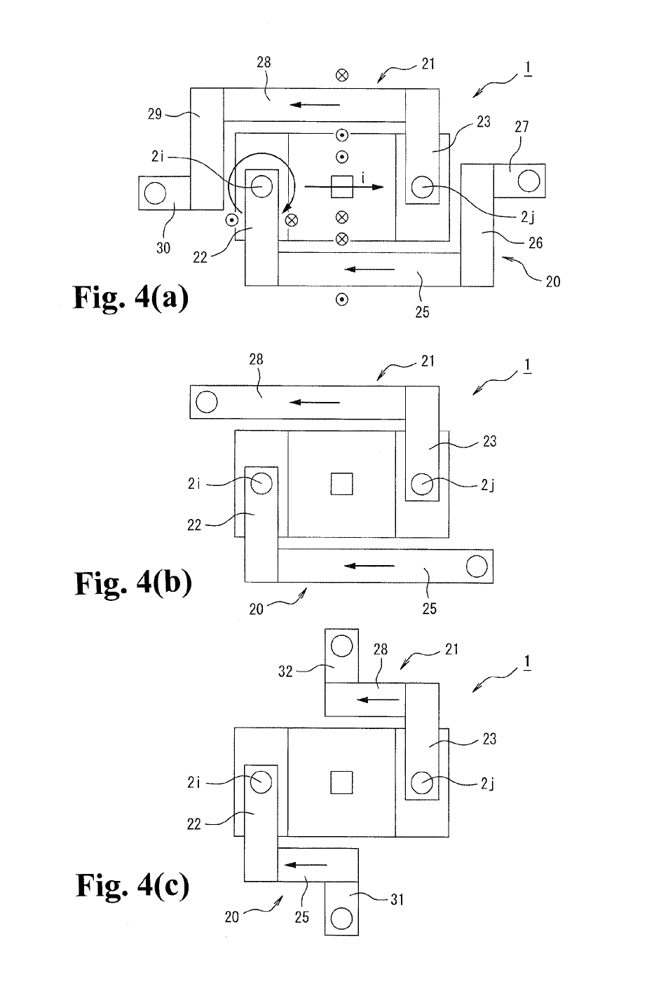

Next, a description will be given, referring to FIGS. 4(a)-4(c), of a second embodiment of the invention.

In the second embodiment, the external connection conductors connected to the external connection terminals 2i and 2j of the fixed contacts 2 are configured so as to strengthen the magnetic field generated in the conductive plate portion 3a of the movable contact 3.

That is, in the second embodiment, the configuration of the external connection conductors 20 and 21 in FIG. 2(a) in the first embodiment is changed, as shown in FIG. 4(a).

Firstly, the external connection conductor 20 includes a first conductor portion 25 extending, along the front surface of the upper case 1a and parallel to the conductive plate portion 3a of the movable contact 3, to the other end of the fixed portion 22 connected to the external connection terminal 2i of the fixed contact 2, a second conductor portion 26 extending rearward from the other end of the conductor portion 25, along the side surface of the upper case 1a, to a position opposite to the external connection terminal 2j, and an external connection conductor portion 27 extending from the other end of the second conductor portion 26 in a direction same as the extension direction of the conductive plate portion 3a of the movable contact 3.

Also, the external connection conductor 21 also includes a first conductor portion 28, a second conductor portion 29, and an external connection conductor portion 30, so that the external connection conductors 20 and 21 are symmetrical with respect to a point.

According to the second embodiment, the fixed portions 22 and 23 of the external connection conductors 20 and 21 are disposed so as not to affect the magnetic field generated by the current flowing through the conductive plate portion 3a of the movable contact 3, in the same way as in the first embodiment. Further, the external connection conductors 20 and 21 have the first conductor portions 25 and 28 extending parallel to the conductive plate portion 3a of the movable contact 3, and the direction of the currents flowing through the first conductor portions 25 and 28 are set so as to be the reverse of that of the current flowing through the conductive plate portion 3a of the movable contact 3, as shown in FIG. 4(a).

Because of this, the magnetic fields generated in the first conductor portions 25 and 28 of the external connection conductors 20 and 21 are superimposed on the magnetic field generated in the conductive plate portion 3a of the movable contact 3, and it is thus possible to increase the magnetic flux density around the conductive plate portion 3a of the movable contact 3. Consequently, it is possible to generate greater Lorentz forces opposing the magnetic forces generated in the opening direction in the movable contact 3 when current is conducted. As a result of this, it is possible to reliably prevent the movable contact 3 from opening when current is conducted. Because of this, it is possible to further reduce the pressing force of the contact spring 12 supporting the movable contact 3, as a result of which it is also possible to further reduce the thrust generated by the operating electromagnet 4, and it is thus possible to further reduce the size of the overall configuration.

In the second embodiment, a description has been given of a case in which the external connection conductors 20 and 21 are formed in a U-shape, but the invention not being limited to this, it is possible to obtain working effects the same as heretofore described even when an L-shape is configured by the fixed portions 22 and 23 and the first conductor portions 25 and 28 acting concurrently as the external connection conductor portions, as shown in FIG. 4(b). Furthermore, an arrangement may be such that the length of the first conductor portions 25 and 28 is halved, and external connection conductor portions 31 and 32 extending from the free ends of the first conductor portions 25 and 28 in a direction opposite to that of the fixed portions 22 and 23, as shown in FIG. 4(c).

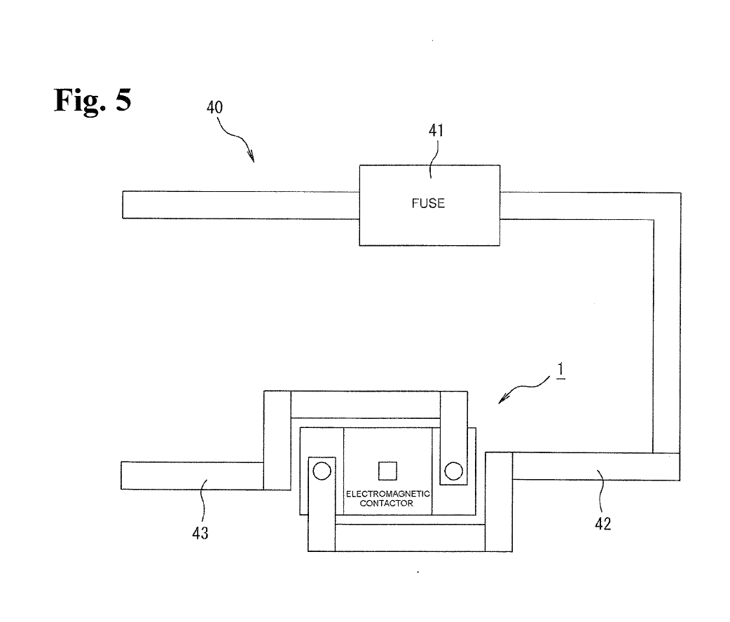

Also, a protection unit 40 of the electromagnetic contactor 1 is configured of a busbar 42 having a fuse 41 interposed between a direct current power source and the external connection terminal 2i of the fixed contact 2 of the electromagnetic contactor 1 and a busbar 43 connecting the external connection terminal 2j of the fixed contact 112 of the electromagnetic contactor 1 and a load, as shown in FIG. 5. Further, it is possible to obtain working effects the same as in the second embodiment even when a portion of the busbar 42 connected to the external connection terminal 2j of the fixed contact 2 is formed in the same shape as the external connection conductor 20 shown in FIG. 4(a), and the busbar 43 is formed in the same shape as the external connection conductor 21.

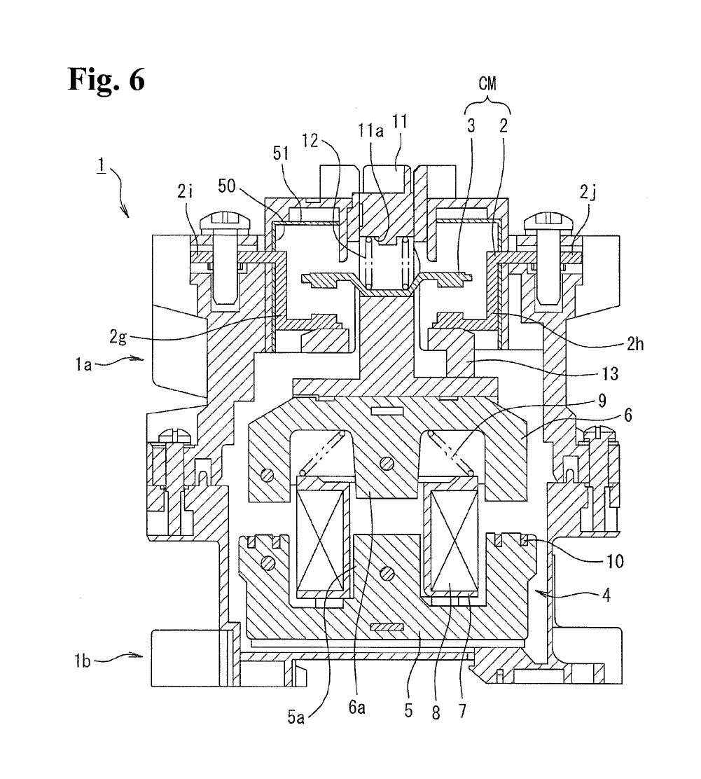

Furthermore, a description will be given, referring to FIG. 6, of a third embodiment of the invention.

In the third embodiment, an arrangement is such that the contact mechanism CM is not affected by the magnetic fields of the external connection conductors 20 and 21.

That is, in the third embodiment, a configuration is adopted wherein a magnetic shielding body 51 is disposed on the inner wall of a contact housing space 50 of the upper case 1a housing the L-shaped conductive plate portions 2g and 2h of the fixed contacts 2, so as to enclose the L-shaped conductive plate portions 2g and 2h, as shown in FIG. 6.

Herein, the magnetic shielding body 51 is formed into a tub-shaped magnetic body whose lower end is opened, and an insulating film or insulating layer is formed on at least an inner peripheral surface of the magnetic shielding body 51 contacting the second conductive plate portions 2e and 2f of the L-shaped conductive plate portions 2g and 2h.

According to the third embodiment, as the whole of the contact mechanism CM is covered with the magnetic shielding body 51, it is possible to magnetically shield the magnetic fields generated by the currents flowing through the external connection conductors 20 and 21 connected to the external connection terminals 2i and 2j disposed outside the upper case 1a. Because of this, it is possible to reliably prevent an external magnetic field from affecting the magnetic fields generated by the currents flowing through the L-shaped conductive plate portions 2g and 2h of the fixed contacts 2 and the conductive plate portion 3a of the movable contact 3. Consequently, it is possible to reliably prevent the movable contact 3 from opening when current is conducted without weakening the Lorentz forces opposing the electromagnetic forces causing the movable contact to open when current is conducted.

In this case, as the magnetic fields generated in the external connection conductors 20 and 21 are magnetically shielded by the magnetic shielding body 51, it is possible to optionally set the connection direction of the external connection conductors 20 and 21.

In the third embodiment, a description has been given of a case in which the magnetic shielding body 51 is disposed so as to cover the whole of the contact mechanism CM configured of the L-shaped conductive plate portions 2g and 2h of the fixed contacts and the conductive plate portion 3a of the movable contact 3. However, the invention is not limited to the heretofore described configuration, and it is only necessary for the magnetic shielding body 51 to prevent the magnetic fields generated by the currents flowing through the external connection conductors 20 and 21 from affecting regions in which Lorentz forces are generated. Because of this, it is possible to form the magnetic shielding body 51 in only the opposing side surface portions opposite to the external connection terminals 2i and 2j, or adopt a configuration wherein the front and rear side surfaces are removed from the configuration of FIG. 6.

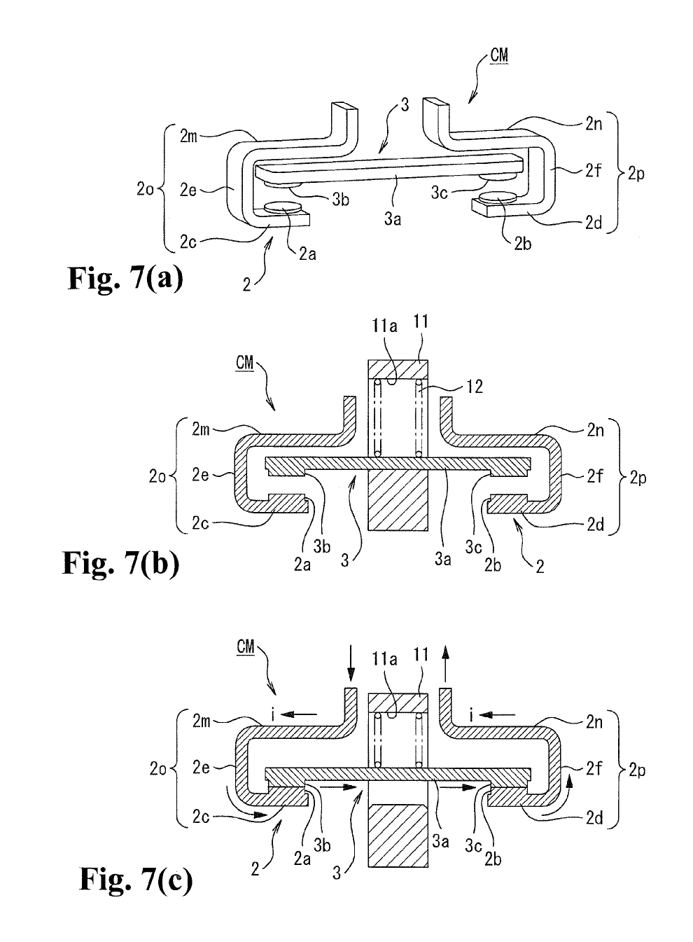

In the first to third embodiments, a description has been given of a case in which the L-shaped conductive plate portions 2g and 2h are formed in the fixed contacts 2 into a shape such as to generate Lorentz forces. However, the invention; not being limited to the heretofore described configurations, has a configuration same as those of the first to third embodiments except that, in the heretofore described configuration of FIG. 3 in the first embodiment, the second conductive plate portions 2e and 2f of the L-shaped conductive plate portions 2g and 2h of the fixed contacts 2 are bent so as to cover the upper end sides of the end portions of the conductive plate portion 3a of the movable contact 3, thus forming third conductive plate portions 2m and 2n parallel to the conductive plate portion 3a, and thereby forming U-shaped conductive plate portions 2o and 2p, as shown in FIGS. 7(a)-7(c).

According to this configuration, when the contact mechanism CM attains the closed condition, as shown in FIG. 7(c), a large current in the order of, for example, several ten kiloamperes input from, for example, the external connection terminal 2i of the fixed contact 2 connected to a direct current power supply (not shown) is supplied to the movable contact portion 3b of the movable contact 3 through the third conductive plate portion 2m, second conductive plate portion 2e, first conductive plate portion 2c, and fixed contact portion 2a. The large current supplied to the movable contact portion 3b is supplied to the fixed contact portion 2b through the conductive plate portion 3a and movable contact portion 3c. The large current supplied to the fixed contact portion 2b is supplied to the first conductive plate portion 2d, second conductive plate portion 2f, third conductive plate portion 2n, and external connection terminal 2j, and a current conduction path through which the current is supplied to an external load is formed.

At this time, electromagnetic repulsion forces are generated in a direction such as to cause the movable contact portions 3b and 3c to open between the fixed contact portions 2a and 2b of the fixed contacts 2 and the movable contact portions 3b and 3c of the movable contact 3.

However, as the fixed contacts 2 are such that the U-shaped conductive plate portions 2o and 2p are formed by the first conductive plate portions 2c and 2d, second conductive plate portions 2e and 2f, and third conductive plate portions 2m and 2n respectively, as shown in FIG. 3, the currents in the third conductive plate portions 2m and 2n of the fixed contacts 2 and the current in the conductive plate portion 3a of the movable contact 3 opposite thereto flow in opposite directions. Because of this, from the relationship between magnetic fields formed by the third conductive plate portions 2m and 2n of the fixed contacts 2 and the current flowing through the conductive plate portion 3a of the movable contact 3, it is possible, in accordance with Fleming's left-hand rule, to generate Lorentz forces which press the conductive plate portion 3a of the movable contact 3 against the fixed contact portions 2a and 2b of the fixed contacts 2. Due to the Lorentz forces, it is possible to oppose the electromagnetic repulsion forces generated in the opening direction between the fixed contact portions 2a and 2b of the fixed contacts 2 and the movable contact portions 3b and 3c of the movable contact 3, and thus possible to prevent the movable contact portions 3b and 3c of the movable contact 3 from opening.

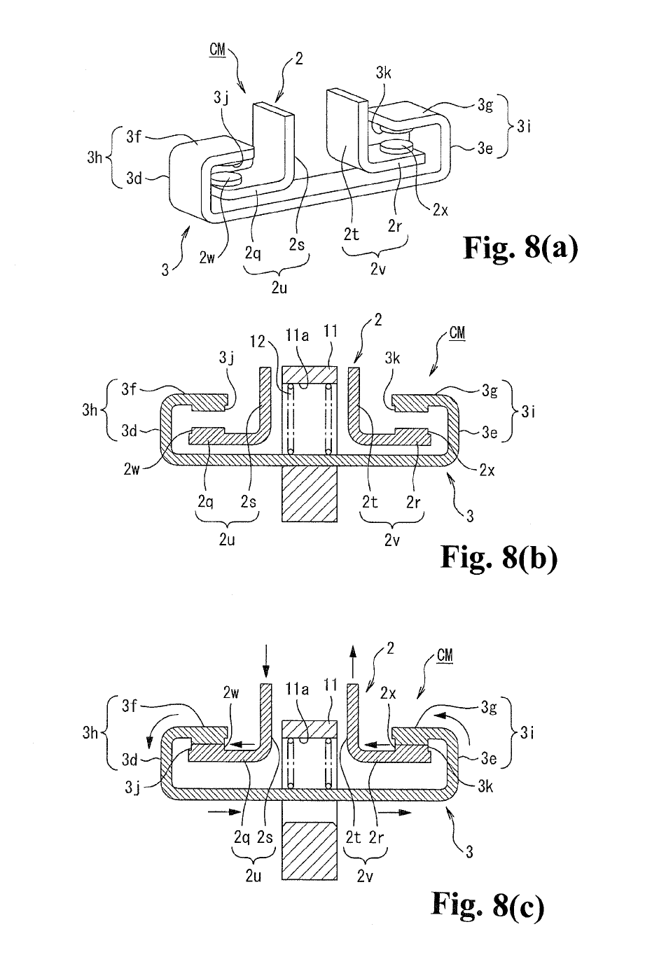

Furthermore, an arrangement may be such that the shape of the movable contact 3 is changed, as shown in FIGS. 8(a)-8(c), to generate Lorentz forces opposing the electromagnetic forces in the opening direction when current is conducted.

That is, a U-shaped bent portion 3h, 3i bent toward the upper side of the conductive plate portion 3a is formed by a first conductive plate portion 3d, 3e extending upward from each respective end side of the conductive plate portion 3a of the movable contact 3 and a second conductive plate portion 3f, 3g extending inward from the upper end of the first conductive plate portion 3d, 3e, as shown in FIGS. 8(a)-8(c). Movable contact portions 3j and 3k are formed on the leading end side lower surfaces of the second conductive plate portions 3f and 3g of the U-shaped bent portions 3h and 3i respectively.

Also, each of the fixed contacts 2 is such that an L-shaped conductive plate portion 2u, 2v is formed by a fourth conductive plate portion 2q, 2r, extending inward, which is opposite between the conductive plate portion 3a and second conductive plate portion 3f, 3g which form the U-shaped bent portion 3h, 3i of the movable contact 3, in the open state of the contact mechanism CM, and a fifth conductive plate portion 2s, 2t extending upward from the inward end of the fourth conductive plate portion 2q, 2r through the inner side of the inner side end portion of the U-shaped bent portion 3h, 3i of the movable contact 3. Further, fixed contact portions 2w and 2x are formed in positions on the fourth conductive plate portions 2q and 2r opposite to the movable contact portions 3j and 3k of the movable contact 3.

According to the configuration of FIGS. 8(a)-8(c), when the contact mechanism CM attains the closed condition, as shown in FIG. 8(c), a large current in the order of, for example, several ten kiloamperes input from, for example, the external connection terminal 2i of the fixed contact 2 connected to a direct current power supply (not shown) is supplied to the movable contact portion 3j of the movable contact 3 through the fifth conductive plate portion 2s, fourth conductive plate portion 2q, and fixed contact portion 2w. The large current supplied to the movable contact portion 3j is supplied to the fixed contact portion 2x through the second conductive plate portion 3f, first conductive plate portion 3d, conductive plate portion 3a, first conductive plate portion 3e, second conductive plate portion 3g, and movable contact portion 3k. The large current supplied to the fixed contact portion 2x forms through the fourth conductive plate portion 2r, fifth conductive plate portion 2t, and external connection terminal 2j, and a current conduction path, a current conduction path supplied to an external load.

At this time, electromagnetic repulsion forces are generated in a direction such as to cause the movable contact portions 3j and 3k to open between the fixed contact portions 2w and 2x of the fixed contacts 2 and the movable contact portions 3j and 3k of the movable contact 3.

However, as the movable contact 3 is such that the U-shaped bent portion 3h, 3i is formed by the conductive plate portion 3a, first conductive plate portion 3d, 3e, and second conductive plate portion 3f, 3g, the current in the conductive plate portion 3a of the movable contact 3 and the currents in the fourth conductive plate portions 2q and 2r of the fixed contacts 2 flow in opposite directions. Because of this, Lorentz forces which press the movable contact portions 3j and 3k of the movable contact 3 against the fixed contact portions 2w and 2x of the fixed contacts 2 can be generated in the conductive plate portion 3a by the current flowing through the conductive plate portion 3a of the movable contact 3 and the magnetic field formed by the fourth conductive plate portions 2q and 2r of the fixed contacts 2, as shown in FIG. 8(c). Due to the Lorentz forces, it is possible to oppose the electromagnetic repulsion forces generated in the opening direction between the fixed contact portions 2w and 2x of the fixed contacts 2 and the movable contact portions 3j and 3k of the movable contact 3, and thus possible to prevent the movable contact portions 3j and 3k of the movable contact 3 from opening when a large current is conducted.

Furthermore, with the configuration of FIGS. 8(a)-8(c), as the L-shaped conductive plate portions 2u and 2v are formed in their respective fixed contacts 2, magnetic flux strengthening portions are formed on the upper sides of the second conductive plate portions 3f and 3g of the movable contact 3 by the fifth conductive plate portions 2s and 2t of the L-shaped conductive plate portions 2u and 2v, meaning that it is also possible to generate Lorentz forces the same as those in the first embodiment, and thus possible to more potently prevent the movable contact 3 from opening.

In the first to third embodiments, a description has been given of a case in which the fixed portions 22 and 23 of the external connection conductors 20 and 21 are disposed in a direction perpendicular to the current direction of the movable contact 3, but the invention not being limited to this, the fixed portions 22 and 23 may be crossed at an angle such that the magnetic fields generated by the currents flowing through the fixed portions 22 and 23 do not cause the Lorentz forces to decrease.

### INDUSTRIAL APPLICABILITY

According to the invention, it is possible to provide an electromagnetic contactor with which it is possible to suppress electromagnetic repulsion forces which cause a movable contact to open when current is conducted, without any effect of the magnetic fields of external connection conductors.

### REFERENCE SIGNS LIST

1 . . . Main body case, 1a . . . Upper case, 1b . . . Lower case, 2 . . . Fixed contact, 2a, 2b . . . Fixed contact portion, 2c, 2d . . . First conductive plate portion, 2e, 2f . . . Second conductive plate portion, 2g, 2h . . . L-shaped conductive plate portion, 2i, 2j . . . External connection terminal, 2m, 2n . . . Third conductive plate portion, 2o, 2p . . . U-shaped conductive plate portion, 2q, 2r . . . Fourth conductive plate portion, 2s, 2t . . . Fifth conductive plate portion, 2u, 2v . . . L-shaped conductive plate portion, 2w, 2x . . . Fixed contact portion, Movable contact, 3a . . . Conductive plate portion, 3b, 3c . . . Movable contact portion, 3d, 3e . . . First conductive plate portion, 3f, 3g . . . Second conductive plate portion, 3h, 3i . . . U-shaped bent portion, 3j, 3k . . . Movable contact portion, 4 . . . Operating electromagnet, 5 . . . Fixed iron core, 6 . . . Movable iron core, 8 . . . Electromagnetic coil, 9 . . . Return spring, 11 . . . Contact holder, 12 . . . Contact spring, 13 . . . Stopper, 20, 21 . . . External connection conductor, 22, 23 . . . Fixed portion, 225, 28 . . . First conductor portion, 26, 29 . . . Second conductor portion, 27, 30 . . . External connection conductor portion, 31, 32 . . . External connection conductor portion, 40 . . . Protection unit, 41 . . . Fuse, 42, 43 . . . Busbar, 50 . . . Contact housing space, 51 . . . Magnetic shielding body

1. An electromagnetic contactor comprising:
a contact mechanism including a pair of fixed contacts having fixed contact portions interposed in a current conduction path, and a movable contact having a pair of movable contact portions capable of contacting to and separating from the pair of fixed contact portions, wherein at least one of the pair of fixed contacts or the movable contact is formed in a shape to form magnetic fields generating Lorentz forces opposing electromagnetic repulsion forces generated in an opening direction between the fixed contact portions and the movable contact portions when current is conducted, and
external connection conductors connected to external connection terminals of the fixed contacts, an attachment direction of fixed portions fixed to the external connection terminal of the fixed contacts being set to cross a current flow direction flowing through the movable contact.

2. The electromagnetic contactor according to claim 1, wherein each of the external connection conductors includes a conductor portion connected on a side opposite to the external connection terminal of the fixed portion in a direction parallel to an extension direction of the movable contact, and the conductor portion has a direction of a current flow reverse to that of the movable contact.

3. The electromagnetic contactor according to claim 2, wherein each of the external connection conductors includes a busbar having a protection unit.

4. An electromagnetic contactor comprising:
a contact mechanism including a pair of fixed contacts having fixed contact portions and interposed in a current conduction path, and a movable contact having a pair of movable contact portions capable of contacting to and separating from the pair of fixed contact portions, wherein at least one of the pair of fixed contacts or the movable contact is formed in a shape to form magnetic fields generating Lorentz forces opposing electromagnetic repulsion forces generated in an opening direction between the fixed contact portions and the movable contact portions when current is conducted, and
a magnetic body disposed to cover the contact mechanism, the magnetic body suppressing an effect of magnetic fields generated in external connection conductors connected to the fixed contacts.

5. The electromagnetic contactor according to claim 1, wherein the movable contact includes a conductive plate supported by a movable portion and having contact portions on two end sides on a front or rear surface, and
each of the fixed contacts includes an L-shaped conductive plate portion having a first conductive plate portion supporting the fixed contact portion facing the contact portion of the conductive plate and directed toward an outer side of the end of the conductive plate in parallel to the conductive plate, and a second conductive plate portion extending from an outward end portion of the first conductive plate portion through the outer side of the end portion of the conductive plate.

6. The electromagnetic contactor according to claim 5, wherein each of the fixed contacts has a third conductive plate portion extending inward from an end portion of the second conductive plate portion in parallel to the conductive plate and is configured in a C-shape.

7. The electromagnetic contactor according to claim 1, wherein the movable contact includes a conductive plate portion supported by a movable portion, C-shaped bent portions formed on two ends of the conductive plate portion, and contact portions formed on each surface of the C-shaped bent portions facing the conductive plate portion, and
the fixed contacts include L-shaped conductive plate portions having a pair of first conductive plate portions, each having a contact portion formed inside a U-shaped bent portion and disposed in parallel to the conductive plate portion to contact the corresponding contact portion of the movable contact, and second conductive plate portions extending from an inner side end of each of the pair of first conductive plate portions through the inner side of an end portion of the C-shaped bent portion.
